(19) United States
(12) Patent Application Publication
(10) Pub. No.: US 2010/0181135 A1
(43) Pub. Date: Jul. 22, 2010

(54) HYBRID MOTOR VEHICLE

(75) Inventor: Francesco Sbarro, Grandson (CH)

Correspondence Address: DAVIS & BUJOLD, P.L.L.C., 112 PLEASANT STREET, CONCORD, NH, 03301, US

(73) Assignee: ASSYSTEM S.A., Paris (FR)

(21) Appl. No.: 12/664,901

(22) PCT Filed: Jul. 4, 2008
(86) PCT No.: PCT/CH08/00302

§ 371 Date: Dec. 16, 2009

(30) Foreign Application Priority Data
Jul. 5, 2007 (CH) 1083/07

(51) Int. Cl. B60K 17/30

(52) U.S. Cl. 180/253; 180/65.21

(57) ABSTRACT

A highly maneuverable hybrid motor vehicle (10) a passive safety of which is enhanced by the utilization of two independent modules. This vehicle comprises a chassis (11), a body (12) mounted on this chassis, two steered wheels (17, 27) and two driven wheels (17, 27). The chassis (11) supports a front driving and steering unit (13) and a rear driving and steering unit (14). Each driving and steering unit (13, 14) is provided with a supporting member (15, 25) that forms an independent module. This supporting member is constructed so as to support a motor (16, 26) and a wheel (17, 27) which is driven by the motor and articulated with respect to the chassis (11).

This application is a National Stage completion of PCT/CH2008/000302 filed Jul. 4, 2008 which claims priority to Swiss Application No. 01083/07 filed Jul. 5, 2007.

### FIELD OF INVENTION

The present invention concerns a hybrid motor vehicle comprising a chassis, a body mounted on the chassis, two steered wheels and two driven wheels.

### BACKGROUND OF THE INVENTION

Most known motor vehicles have a substantially rectangular chassis, with four wheels arranged at the four corners of the chassis. The body supported by the chassis depends on the intended use and can take several forms, ranging from a cabriolet, through a family sedan, to a utility vehicle or an off-road vehicle with four-wheel drive, etc.

From the engine standpoint any variant can be considered and the current trend is toward vehicles known as hybrids, which comprise an internal combustion engine and an electric motor which can be operated alternatively or at the same time. This trend is related to ecological problems and to a desire to reduce the use of fossil fuels, as well as economic problems caused by the ever-increasing cost of fossil fuels.

The maneuverability of all motor vehicles is limited by the steering radius of their steered wheels, which makes them not very maneuverable and complicated parking operations, especially in the urban environment. The difference between one vehicle and another is small and depends mainly on the size of the chassis. To produce vehicles with four steered wheels is complicated and for that reason this has not been extended to ordinary vehicles.

Passive safety is mainly related to the ability of the vehicle's body to be deformed in the event of impact. A frontal impact is in most cases fatal for the occupants since the front part of the vehicle has limited strength. Most motor vehicles no longer have an independent chassis because the chassis is integrated in a self-supporting body. The impact resistance is better when contact takes place from the side at a certain angle, against the wheels and in a direction in which the most rigid part of the vehicle is aligned with the axis of the impact.

Vehicles of today have numerous drawbacks such as those mentioned above, which designers strive to correct. The measures adopted are individual and each improvement corrects only one drawback, sometimes introducing others in its place or exacerbating certain existing disadvantages. The problem of maneuverability can only be improved upon by reducing size. The problem of fuel consumption can only be improved by reducing vehicle weight and developing low-consumption engines. The problem of pollution can only be solved by the use of ‘clean’ motors such as electric motors. The problem of impact resistance is partially solved by the design of auto bodies intended to form a passenger compartment that deforms not very much if at all, but this corresponds only very partially to what has been achieved so far.

Various attempts have been made to try and solve the existing problems. The German publication DE 31 28 905 A1 describes a motor vehicle with two wheels arranged essentially on the longitudinal axis of the vehicle, at least one of which is a driven wheel, and two lateral wheels arranged respectively on one and on the other side of the axis, whose height can be adjusted. The main characteristic of the said vehicle is that its wheels can be tilted relative to the vertical.

German publication DE 198 00 738 A1 concerns a motor vehicle with four wheels, arranged as before on the longitudinal axis of the vehicle in the case of the two main wheels and at the sides in the case of two additional wheels which can be driven electrically.

American patent U.S. Pat. No. 4,775,021 relates to a motor vehicle with four wheels arranged as in the previously-mentioned publications, along the longitudinal axis and on a transverse axis. All four are driven wheels, but only the front and rear wheels are steered. Their axle pivots on a suspension arm attached to a chassis.

German publication DE 203 13 576 also describes a vehicle with four wheels arranged in a diamond shape, of which only the two wheels on the longitudinal axis are in contact with the ground while the vehicle is moving in a straight line, while the side wheels serve only to ensure that the vehicle remains stable when driving round a curve.

None of the solutions proposed provides a global response to a catalog of requirements whose purpose is to produce a vehicle that satisfies current demands relating to ecology, maneuverability, flexibility, comfort and safety.

### SUMMARY OF THE INVENTION

The present invention is intended to address all these aspects by providing a hybrid motor vehicle which is highly maneuverable and whose passive safety is greatly enhanced, especially in the event of a frontal impact.

This objective is achieved by the motor vehicle according to the invention, in which the chassis supports a driving and steering unit at the front and a driving and steering unit at the rear, each driving and steering unit being arranged to form an independent module and being provided with a supporting member that carries a motor and a wheel driven by the motor, the supporting member being articulated relative to the chassis, in which the driven and steered wheel of the front unit and the driven and steered wheel of the rear unit are substantially aligned on the longitudinal axis of symmetry of the vehicle, respectively at the front and at the rear of the vehicle, in which the two stabilizing wheels can rotate freely and are positioned laterally on either side of the longitudinal symmetry axis of the chassis, and in which the supporting members of the two driving and steering units can pivot about a substantially vertical axis through a rotation angle of 360°.

One of the two driving and steering units can comprise an internal combustion engine and the other unit can comprise an electric motor.

In the embodiment preferred, the supporting members of the two driving and steering units are coupled in such manner that an angular pivoting movement of the front driving and steering unit produces an angular pivoting movement of the rear driving and steering unit, these movements being of equal size but in opposite directions.

The supporting member of each driving and steering unit can be mounted on a bearing with an outer ring connected to the chassis and an inner ring that rotates relative to the outer ring and carries at least the corresponding wheel.

The motor and wheel of each driving and steering unit are preferably carried by the corresponding inner bearing ring and the two inner bearing rings are angularly linked.

Advantageously, each wheel of each driving and steering unit is associated with a suspension carried by the inner bearing ring.

The supporting members of the two driving and steering units can be coupled by at least one flexible element.

### BRIEF DESCRIPTION OF THE INVENTION

The present invention and its advantages will be better understood by reading the following detailed description of an embodiment of the invention, with reference to the attached drawings which are presented for indicative and not limiting purposes and which show:

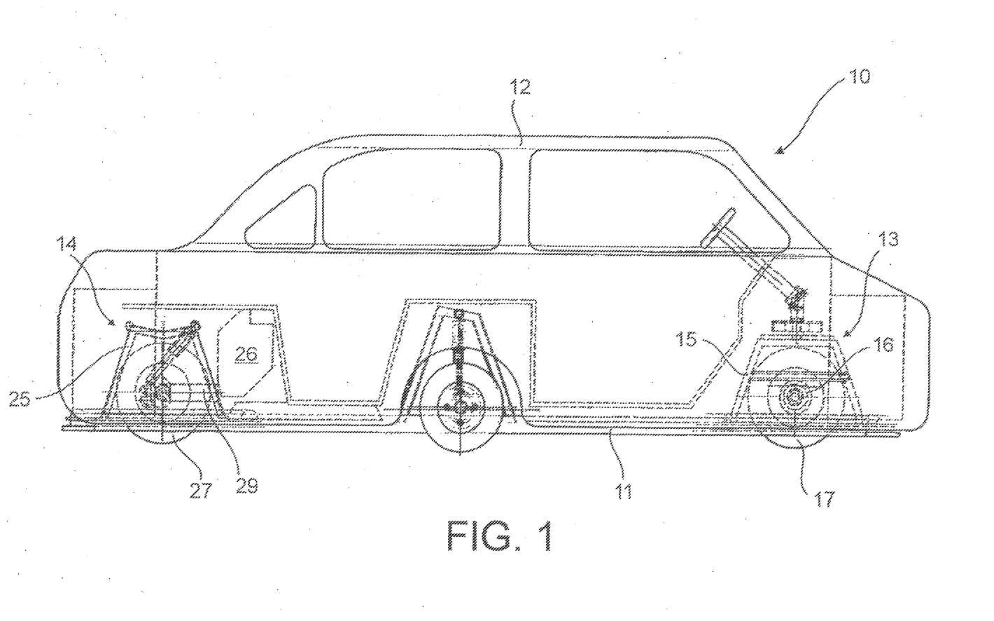

FIG. 1: Schematic representation showing an overall side elevation of the vehicle according to the invention;

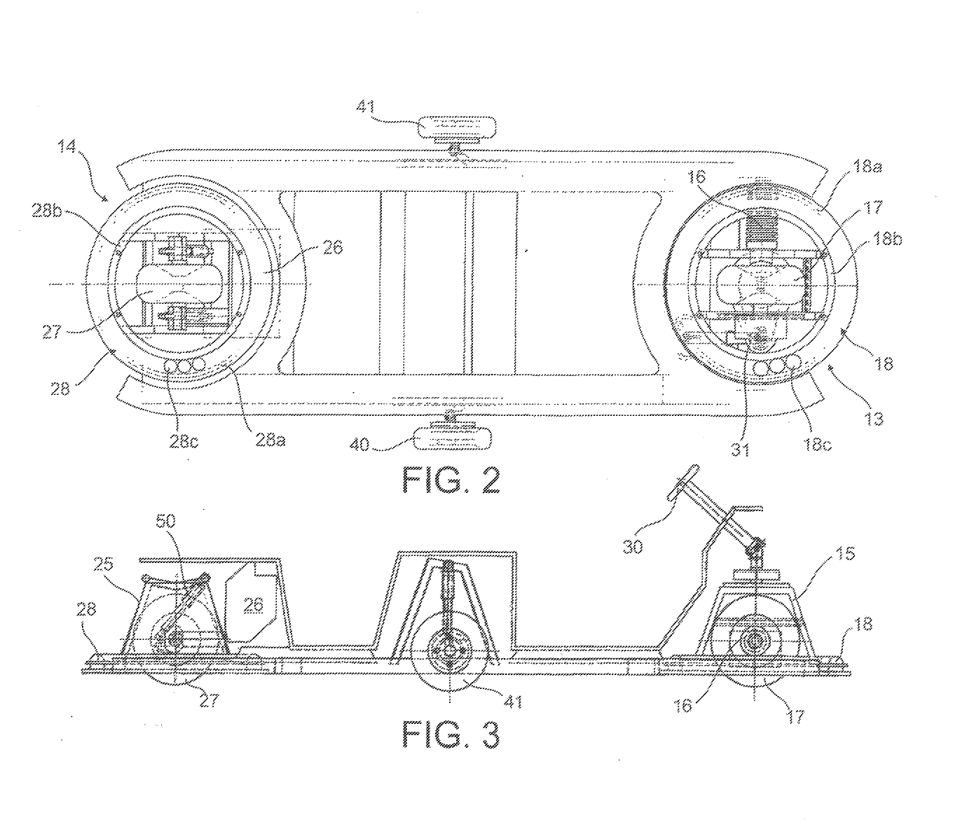

FIG. 2: Schematic plan view of the vehicle in FIG. 1; and

FIG. 3: Partial side elevation of the chassis and the driving and steering units respectively at the front and rear.

### DETAILED DESCRIPTION OF THE INVENTION

Referring to the figures, the motor vehicle 10 according to the invention comprises a chassis 11, a body 12 mounted on the chassis 11, a front driving and steering unit 13 and a rear driving and steering unit 14, each of these units forming an independent module.

The front driving and steering unit 13 has a supporting member 15 that carries a motor 16 and a wheel 17 driven by the motor 16. The supporting member 15 is articulated relative to the chassis 11 and comprises a circular base carrying a ball or roller bearing 18 of large diameter with an outer ring 18a and an inner ring 18b, between which is arranged a crown of balls or rollers 18c. The outer ring 18a is attached firmly to the chassis 11, the joint being formed by welds, bolts or suchlike. The inner ring 18b can rotate relative to the outer ring 18a and carries suspension arms on which the wheel 17 is mounted. The motor 16 is coupled directly to the wheel 17. This motor is advantageously an electric motor of relatively low power, which constitutes an auxiliary motor capable of moving the vehicle on its own or of supplementing the power of a main motor, which will be described below.

The rear driving and steering unit 14 also has a supporting member 25 that carries a motor 26 and a wheel 27 driven by the motor 26. The supporting member 25 is articulated relative to the chassis 11 and comprises a circular base carrying a ball or roller bearing 28 of large diameter with an outer ring 28a and an inner ring 28b, between which is arranged a crown of balls or rollers 28c. The outer ring 28a is attached firmly to the chassis 11, the joint being formed by welds, bolts or suchlike. The inner ring 28b can rotate relative to the outer ring 28a and carries suspension arms on which the wheel 27 is mounted. The motor 26 is coupled directly to the wheel 27. The motor 26, which is the main motor, is preferably an internal combustion engine whose driveshaft 29 is coupled to the rear wheel 27.

The two supporting members, 15 and 25 respectively, comprise a circular base and are coupled to the chassis 11 by bearings in such manner that they can rotate about themselves through 360°. This system solves one of the problems mentioned earlier, namely the maneuverability of the vehicle. In effect, the motor vehicle 10 according to the invention can turn about itself and the system of supporting members gives the vehicle an unequalled steering radius. The angular positions of the front 17 and rear 27 wheels are controlled simultaneously by a steering wheel 30 which, via a reducing gear, for example with a belt 31, is coupled to the front wheel 17. The front 17 and rear 27 wheels are suspended in the classical manner by means of springs and shock-absorbers such as the shock-absorber 50 of the rear wheel 27.

Moreover, a flexible element (not shown) such as a cable, a crossed belt or suchlike, connects the two respective front 15 and rear 25 supporting members in such manner that a rotation of the front supporting member 15 through a given angle, controlled by turning the steering wheel 30, brings about a rotation of the rear supporting member 25 through the same angle but in the opposite direction. This design is at the origin of the great maneuverability of the motor vehicle 10 according to the invention.

The central position of the front 17 and rear 27 wheels mounted inside the circular bases of the supporting members 15 and 25, the latter having diameters essentially equal to the width of the motor vehicle 10, extends the chassis and considerably reinforces the rigidity of the vehicle, giving better resistance to frontal impacts. In effect, before affecting the passenger compartment impacts are absorbed by the deformation of the front supporting member and, in addition, a pneumatic belt in the form of the wheel 17 is also present.

The stability of the motor vehicle 10 is ensured by two lateral stabilizing wheels 40 and 41 mounted to rotate freely on their median axle, which extends transversely relative to the longitudinal axis of symmetry of the vehicle. These wheels are neither steered wheels nor driven wheels, and serve only as supports and stabilizers.

The use of two drive units, respectively an electric motor 16 and an internal combustion engine 26, enables the energy consumption of the motor vehicle 10 to be optimized and adapted to the ecological standards applicable for so-termed ‘clean’ vehicles.

The body 12 is mounted on the chassis 11 by means of bolts or suchlike. This body, which constitutes the passenger compartment, is in fact mounted on the self-supporting chassis. In this way the designer can configure the vehicle is various ways, such as a sedan, a coupe, a cabriolet, a utility vehicle, etc. This concept allows great design flexibility and enables a varied range of vehicles to be produced, using basic elements common to them all.

The advantages of the motor vehicle according to the invention stem from the originality of its design. The basis of the design concept is the use of two independent modules coupled to the self-supporting chassis by large-diameter bearings and comprising both the wheels, with their suspension, and the driving means. Various elements can be modified and supplemented by those with knowledge of the field without infringing the scope of the invention as defined by the claims.

1-8. (canceled)

9. A hybrid motor vehicle (10) comprising:
a chassis (11),
an auto body (12) mounted on the chassis,
two steered wheels (17, 27), and
two driven wheels (17, 27), in which the chassis (11) carries a front driving and steering unit (13) and a rear driving and steering unit (14), each of the front and the rear driving and steering units (13, 14) being configured to form an independent module and being provided with a supporting member (15, 25) that carries a motor (16, 26) and a wheel driven by the motor, the supporting member (15, 25) being articulated relative to the chassis (11), in which the wheel (17) of the front driving and steering unit (13) and the wheel (27) of the rear driving and steering unit (14) are aligned essentially on a longitudinal axis of symmetry of the chassis (11), respectively at a front and rear of the motor vehicle (10),
two stabilizing wheels (40, 41), that are freely rotatable, are positioned laterally on either side of the longitudinal axis of symmetry of the chassis (11), and
the supporting members (15, 25) of the front and of the rear driving and steering units (13, 14) are movable about a substantially vertical axis through a rotational angle of 360°.

10. The motor vehicle according to claim 9, wherein one (14) of the front and the rear driving and steering units (13, 14) comprises an internal combustion engine (26) and an other of the front and the rear driving and steering units (13, 14) comprises an electric motor (16).

11. The motor vehicle according to claim 9, wherein the supporting members (15, 25) of the front and the rear driving and steering units (13, 14) are coupled such that an angular pivoting movement of the front driving and steering unit (13) causes an angular pivoting movement of the rear driving and steering unit (14), and the angular pivoting movements is of equal size but in opposite angular directions.

12. The motor vehicle according to claim 9, wherein the supporting member (15, 25) of each of the front and the rear driving and steering units (13, 14) is mounted on a bearing (18, 28) having an outer ring (18a, 29a) connected to the chassis (11) and an inner ring (18b, 28b), which is rotatable relative to the outer ring and carries at least the corresponding wheel (17, 27).

13. The motor vehicle according to claim 9, wherein the motor (16, 26) and the wheel (17, 27) of each of the front and the rear driving and steering units (13, 14) is carried by the corresponding inner bearing ring (18b, 28b), and the inner bearing rings are angularly linked.

14. The motor vehicle according to claim 12, wherein each wheel (17, 27) of each of the front and the rear driving and steering unit (13, 14) is associated with a suspension carried by the inner bearing ring (18b, 28b).

15. The motor vehicle according to claim 9, wherein the supporting members (15, 25) of the front and the rear driving and steering units (13, 14) are coupled by at least one flexible element.

16. The motor vehicle according to claim 9, wherein the stabilizing wheels (40, 41) are positioned essentially close to a median transverse axis of the chassis (11).
